(19) United States
(12) Patent Application Publication
(10) Pub. No.: US 2003/0040639 A1
(43) Pub. Date: Feb. 27, 2003

(54) Method for the preparation of substituted benzene derivatives

(75) Inventors: Thomas Ruhland, Valby (DK); Mario Rottlander, Valby (DK); Kim Andersen, Virum (DK)

Correspondence Address: DARBY & DARBY P.C., 805 Third Avenue, New York, NY, 10022, US

(73) Assignee: H. Lundbeck A/S, Valby-Copenhagen (DK)

(21) Appl. No.: 10/187,274

(22) Filed: Jun. 26, 2002

Related U.S. Application Data
(63) Continuation of application No. PCT/DK00/00737, filed on Dec. 28, 2000.

(30) Foreign Application Priority Data
Dec. 30, 1999 (DK) PA 1999 01885
Dec. 30, 1999 (DK) PA 1999 01886

(51) Int. Cl. C07F 17/00

(52) U.S. Cl. 556/142

(57) ABSTRACT

A method for the preparation of selectively substituted benzene derivatives by application of solid phase synthesis is disclosed. In particular, the invention provides a novel method for the preparation of substituted benzene derivatives containing two or three groups bound to the benzene ring via nitrogen-, oxygen-, sulphur-, selenium- or carbon-carbon bonds, by application of solid phase chemistry alone or in combination with post cleavage solution phase derivatisation.

This application is a continuation of International application no. PCT/DK00/00737, filed Dec. 28, 2000. The disclosure of the prior application is hereby incorporated by reference, in its entirety.

The present invention provides a method for the preparation of selectively substituted benzene derivatives by application of solid phase synthesis.

In particular, the invention provides a novel method for the preparation of substituted benzene derivatives containing two or three groups bound to the benzene ring via nitrogen-, oxygen-, sulphur-, selenium- or carbon-carbon bonds, by application of solid phase chemistry alone or in combination with post cleavage solution phase derivatisation.

### BACKGROUND OF THE INVENTION

Parallel synthesis and split and mix synthesis have become an important tool in the search for new compounds in e.g. the pharmaceutical industry. Using these concepts, a large number of compounds are synthesised. Parallel synthesis is a particular form of chemical synthesis where a large number of chemical syntheses are performed separately to obtain a large number of new single discrete compounds, typically for research purposes, for example a large number, often hundreds, of analogues of a particular molecule in order to determine which analogue has the most desirable activities in a specific assay. Split and mix synthesis is another form for organisation of organic synthesis where a large number of compounds are synthesised as mixtures of compounds. Combinatorial chemistry is a form of parallel synthesis and split and mix synthesis where the order and the features of the individual steps are performed using a particular combinatorial approach.

Solid phase synthesis alone or in combination with post cleavage derivatisation is a technology to perform parallel and split and mix synthesis. In solid phase synthesis, the substrate for the synthesis is linked to a suitable polymer, and when the solid phase synthesis sequence is completed, the final products are cleaved from the polymer. In certain cases, solution phase synthesis steps are performed after cleavage from the polymer to obtain the desired final products.

In addition, to its application within parallel and split and mix synthesis, solid phase synthesis is applicable for the synthesis of organic compounds in general within a variety of chemical classes.

Previous disclosures on the subject of preparing benzene derivatives containing two or three groups bound to the benzene ring via nitrogen-, oxygen-, sulphur-, or selenium-carbon bonds according to the invention in the solution phase, are known to the person skilled in the art. One particular method is described by Pearson A. J. et. al J. Org. Chem. 1992, 57, 3583-89. The described reaction comprises reaction of a substituted η⁶-dichlorobenzene- or η6- trichlorobenzene-η⁵-cyclopentadienyliron(II) hexafluorophosphate or analogous ruthenium complexes with appropriate nucleophiles in a consecutive manner. When the derivatisation is brought to completion, the final products are obtained by decomplexation using a suitable donor ligand such as acetonitrile or phenanthroline and visible light. The applicability of this type of chemistry is limited by the fact that the final product is difficult to remove from the reaction mixture by standard methods. The application of the Pearson-type chemistry in the synthesis of unsymmetrically substituted benzene derivatives is depending on highly selective mono substitution of η⁶-dichlorobenzene- or η⁶-trichlorobenzene- η⁵-cyclopentadienyliron(II) hexafluorophosphate in the reaction with nucleophiles.

The present invention provides a method for the preparation of benzene derivatives containing two or three groups selectively bound to the benzene ring via nitrogen-, oxygen-, sulphur-, selenium-, or carbon-carbon bonds in solid phase synthesis;

Further the present invention provides a method for applying the Pearson-type chemistry in the solid phase. This provides a synthesis method wherein the polymer-bound synthesis intermediate after the decomplexation reaction is easily isolated and highly selective nucleophilic mono-substitutions are obtained in the reaction with polymer bound nucleophiles due to the high dilution principle of solid phase synthesis.

### SUMMARY OF THE INVENTION

The invention provides a method for the preparation of substituted benzene derivatives by solid phase synthesis by subjecting the polymer bound intermediate of formula IV, to the complex of formula V resulting in the complex of formula VII, which is subjected to the nucleophiles R³′H and is subsequently and optionally subjected to R4′H to obtain compounds of formula VIII:

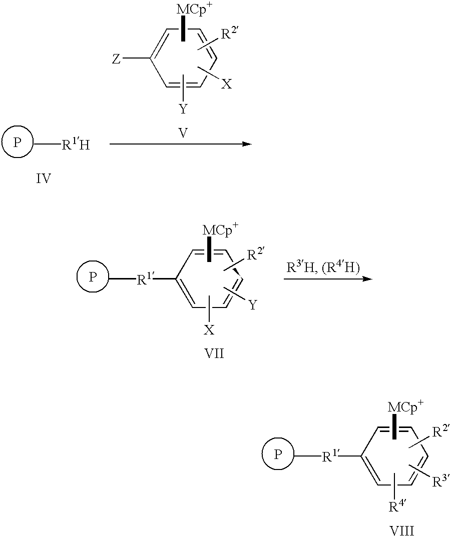

wherein IV, R³′H and R⁴′H each have one reactive nucleophilic centre under the reaction conditions applied; R²′ represents an optional substituent; X and Y represents hydrogen or halogen, with the proviso that they are not both hydrogen; Z is halogen;

\mathring{P} represents the solid support;

MCp⁺ represents

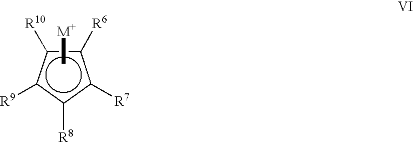

wherein R⁶-R¹⁰ represent hydrogen or C₁₋₆-alkyl; M is Fe or Ru;

whereby the substituted benzene derivative VIII is obtained, which is decomplexed, optionally derivatised, cleaved from the support, and optionally further derivatised.

The positively charged complexes of formulas V, VII and VIII all contain a counterion such as PF₆³¹ , BPh₄⁻, SO₃CF₃⁻, or another negatively charged ion.

By applying the method of the invention, compounds are prepared which are useful for screening purposes, as pharmaceuticals, etc.

Alternatively, by the method of the invention, libraries of compounds are prepared. The library of compounds is optionally still attached to the solid support.

### DETAILED DESCRIPTION OF THE INVENTION

The groups R¹′, R²′, R³′ and R⁴′ may be converted to the desired groups R¹, R², R³ and R⁴, respectively, in the final product by decomplexation and optional derivatisation followed by cleavage from the support and optional derivatisation. Accordingly, each of the groups R¹′, R²′, R³′ and R⁴′ are selected in such a way that they may be converted to the desired substituents R¹, R², R³ and R⁴ or they may be identical to the substituents R¹′, R²′, R³′ and R⁴′.

The groups R¹′, R³′ and R⁴′ independently represent RSe, RS, RO, or R′RN, or R″R′″CH, wherein R represents a suitable chosen chemical moiety with restrictions not to contain structural elements which can interfere with the reaction sequence applied, R′ is hydrogen, or alone or together with R form a suitable chosen chemical moiety with restrictions not to contain structural elements which can interfere with the reaction sequence applied; and R″ and R′″ represent groups which are suitable for stabilising the carbanion R′R′″CH⁻. For the reaction to be specific and controllable, the nucleophiles must only contain one dominating reactive centre or they must be symmetrical.

R²′ represents the group R² in the final product prior to optional derivatisation on the solid support or optional post cleavage derivatisation. R² in the final product represents optional substituents which can be arbitrarily chosen with restrictions not to contain structural elements which can interfere with the reaction sequence applied. The substituents R² and R⁴ are optional. The substitution pattern of the final product is dependent on the structure of VI, as only one of X or Y being halogen will preclude the substituent R⁴ in the final product. R² is selected in the starting material for the complex VII.

In a preferred embodiment of the invention, R²′ represents an optional substituent which does not interfere with the reactions performed. In preferred embodiments of the invention, R²′ represents hydrogen or alkyl. In a more preferred embodiment of the invention, R²′ represents hydrogen or methyl.

In a preferred embodiment of the invention, R³′H represents aryl-OH, alkyl-OH, aryl-SH, alkyl-SH, cycloalkyl-OH, cycloalkyl-SH, alkyl-SeH, aryl-SeH, or R¹⁷R¹⁸NH, wherein R¹⁷ and R¹⁸ independently represent alkyls, or R¹⁷ and R¹⁸ together form a 4-8 membered ring, which optionally contains further heteroatoms and which is optionally substituted one or more times, and which is optionally partially saturated. All of the aryls and alkyls are optionally substituted.

In a particularly preferred embodiment of the invention, R³′H represents aryl-OH, aryl-SH, aryl-SeH. The aryl is optionally substituted one or more times with substituents such as alkyl, aryl, alkoxy, alkylsulfanyl, dialkylamino, wherein the dialkyls are optionally forming a 4-8-membered ring, which optionally contains further nitrogen, oxygen or sulphur atoms.

In a more preferred embodiment of the invention, R³′H represents phenol, 5-hydroxy-1,3-20 benzodioxolane, 5-hydroxy-1,4-benzodioxane, 2-methoxyphenol, 3-dimethylaminophenol, 4-methylphenol, 4-methylsulfanylphenol, 2-methylphenol, 4-methoxyphenol, 2,6-dimethoxyphenol, 3-(4-morpholinyl)phenol, 3,4,5-trimethoxyphenol, 3-diethylaminophenol, selenophenol or thiophenol.

In another preferred embodiment of the invention, R³′H represents R¹⁷R¹⁸NH, wherein R¹⁷ and R¹⁸ independently represent alkyls, or R¹⁷ and R¹⁸ together form a 4-8 membered ring, which optionally contains further heteroatoms and which is optionally substituted one or more times, and which is optionally partially saturated, and even more preferred R¹⁷R¹⁸NH represents 4-morpholine, piperazine, 2,6-dimethylmorpholine, 2-hydroxymethylpyrrolidine.

In a preferred embodiment of the invention, R³′H represents alkyl-X^{N}H, alkoxyalkyl-X^{N}H or cycloalkyl-X^{N}H wherein X^{N} is O, S, Se, NH or NR′ wherein R′ is a substituent which does not interfere with the reaction sequence. An even more preferred embodiment of the invention is wherein R³′H represents alkoxyalkylalcohol or cyclohexylalcohol. In the most preferred embodiment of the invention, R³′H represents ethoxyethanol, or cyclohexylmercaptane.

In the above, the embodiments of R³′H are also the preferred embodiments of R⁴′H.

A further embodiment of the invention is wherein R³′H and R⁴′H are identical and added simultaneously to the compound of formula VII, thereby affording a symmetrically substituted complex:

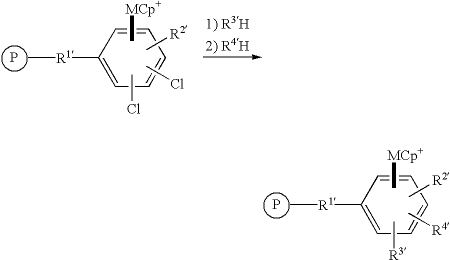

In another embodiment of the above reaction, R³H and R⁴H together are forming a bi-functional nucleophile which can be attached to the phenyl ring and form a fused ring:

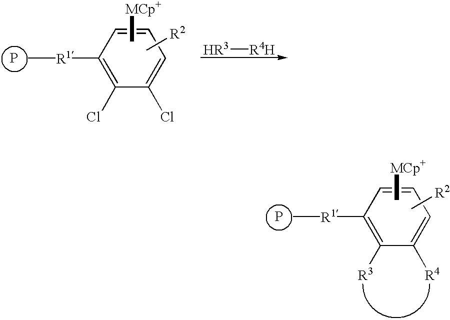

In this particular aspect of the invention, HR³-R⁴H is represented by the following structures:

HX^{N}—(CR^{g}R^{h})ₛ—D—(CR^{J}R^{k})ₜ—X^{N}H

wherein R^{g}, R^{h}, R^{j} and R^{k} represent hydrogen or optional substituents and s is 1 or 2 and t is 1 or 2; and wherein X^{N} is as defined above; D represents a heteroatom such as O, S, Se, NR^{D} wherein R^{D} represents hydrogen, or a substituent which does not interfere with the applied reaction sequence, or D represents a bond. Optionally one of R^{g} or R^{h} together with one of R^{J} or R^{k} form a ring structure; or R^{g} and R^{h} or R^{J} and R^{k} together form a ring. Optionally the ring is partially saturated and it can optionally be substituted if the substituents do not interfere with the reaction sequence.

or HR³-R⁴H is represented by the structure:

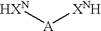

wherein X^{N} is as defined above, wherein A represents an aromatic ring system and the groups HX^{N} are attached to A at adjacent positions.

Especially preferred embodiments of the invention, are wherein HR³-R⁴H is ethylenediamine, or 2,3-dihydroxy-naphthalene. Preferred embodiments of the invention are wherein R¹′ represents a diamine of the formula XI

N(R^{e})—(CR^{a}R^{b})ₚ—L—(CR^{c}R^{d})_{q}—(R^{f})N XI

wherein R^{e} and R^{f} independently represent hydrogen or alkyl or R^{e} and R^{f} together form a ring structure; R^{a}, R^{b}R^{c} and R^{d} represent hydrogen or optional substituents and p is 1 or 2 and q is 1 or 2; L represents a heteroatom such as O, S, Se, NH, NR^{L} wherein R^{L} represents an optional substituent, which does not interfere with the applied reaction sequence; or L represents a bond. Optionally one of R^{a} or R^{b} together with one of R^{c} or R^{d} form a ring structure, or R^{a} and R^{b} or R^{c} and R^{d} form a ring.

In a preferred embodiment of this invention, R¹′ is a cyclic diamine of the formula X

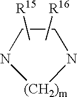

wherein m represents 2, 3 or 4; and R¹⁵ and R¹⁶ represent hydrogen, alkyl or aryl;

Especially preferred embodiments are wherein R¹′ represents a piperazinyl, or a homopiperazinyl moiety.

The reaction between the polymer bound nucleophile IV and the complex V and the reaction between the nucleophile R³′H and the polymer bound complex of formula VII are performed in an aprotic solvent such as dry tetrahydrofuran either by the use of an appropriate base such as potassium carbonate or by deprotonation of the nucleophile, R³′H, using a base such as sodium hydride prior to the reaction. Optionally, for both X and Y being halogen, of which chlorine and fluorine are preferred, in the intermediate of formula VII, the reaction is performed by simultaneous addition of two nucleophiles of formula R³′H and R⁴′H or HR³-R⁴H using the reaction conditions described above.

Following the reactions leading to VIII, the reaction sequence outlined below is applied

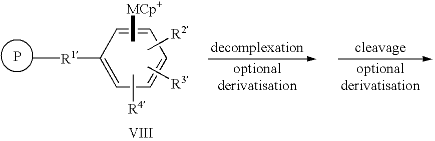

wherein R²′, R³′ and R⁴′, respectively, are as defined above, whereby a compound of the formula A, B, C or D as below is formed:

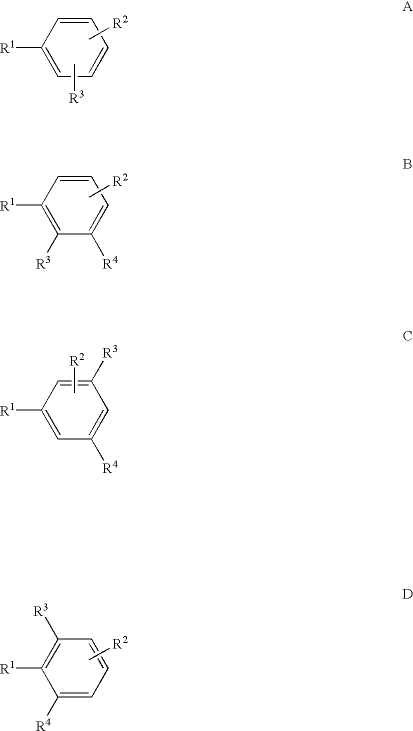

wherein R¹, R², R³ and R⁴ represent the substituents R¹′, R²′, R³′ and R⁴′, respectively, in the final product;

Optionally R³ and R⁴ together, or one of R³ and R⁴ together with R¹ or R² form a ring-containing chemical moiety fused to the benzene ring with the restrictions not to contain structural elements which can interfere with the reaction sequence applied;

The compound of formula VIII is decomplexed according to literature procedures (Pearson et al., J. Org. Chem. 1996, 61, 1297-1305). Decomplexation is carried out by using a suitable donor ligand such as acetonitrile or phenanthroline and visible light. In a preferred embodiment of the invention, 1,10-phenanthroline is used in a 3:1 mixture of pyridine/water and irradiated with visible light. The polymer support is then filtered and washed until the washing solution is colourless.

Cleavage is carried out by methods known in the art and is dependent upon the choice of polymer support and the synthesis strategy chosen.

Derivatisations include reactions known to the skilled person to be performed on the solid phase or in solution phase if the derivatisation follows the cleavage reaction.

The cleavage could also finalise the reaction sequence and the compound is then not further derivatised. The choice of strategy is dependent upon the desired structure of the final products.

Depending on the nature of R¹′, the linking and the cleavage strategies, different functionalities may be introduced in the resulting molecule. Several examples of such functionalities and the usefulness of the method of the present invention, depending on the chosen strategy is demonstrated below;

In a specific embodiment of the invention, cleavage and derivatisation is performed simultaneously:

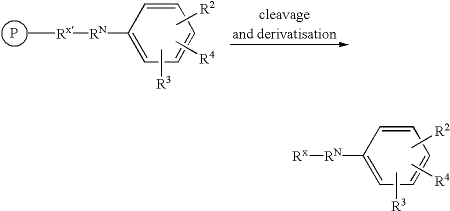

and involves the linking functionality —R^{x}′-R^{N}—, wherein —R^{N}— is a diamine such as a group of the formula:

N(R^{e})—(CR^{a}R^{b})ₚ—L—(CR^{c}R^{d})_{q}—(R^{f})N XI

wherein R^{a}, R^{b}, R^{c}, R^{d}, R^{e}, R^{f}, p, q and L are all as defined above.

and wherein the

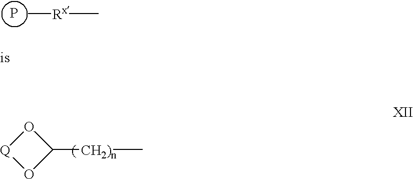

wherein n is 1-12 and Q(OH)₂ is a polymer bound diol.

When the solid phase reaction sequence is brought to completion including the decomplexation step, the polymer bound intermediate XVI

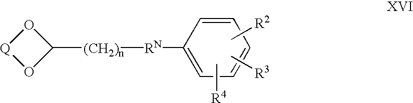

is reacted with an optionally substituted hydrazine of the formula

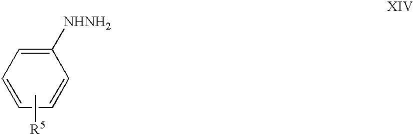

wherein R⁵ represents one or more optional substitutents with the proviso that one of the ortho-positions to the hydrazine substituent are unsubstituted; whereby an indole derivative of the formula:

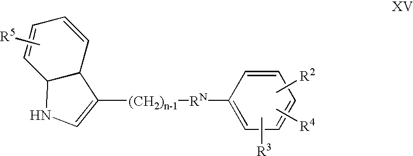

is formed simultaneously with cleavage from the solid support.

The indole formation according to the method above is performed by the reaction of acetals of formula XVI with aryl hydrazines of formula XIV resulting in the corresponding hydrazones, which subsequently are converted into indoles by means of the Fischer indole synthesis. The synthesis sequence is preferably performed as a one-pot procedure using a Lewis acid catalysts, preferably zinc chloride or boron fluoride, or protic acids, preferably sulfuric acid or phosphoric acid, in a suitable solvent such as acetic acid or ethanol at an elevated temperature.

A preferred embodiment of the invention described above is wherein R^{N} is represented by the cyclic structure of formula X, and Q is as shown in detail below:

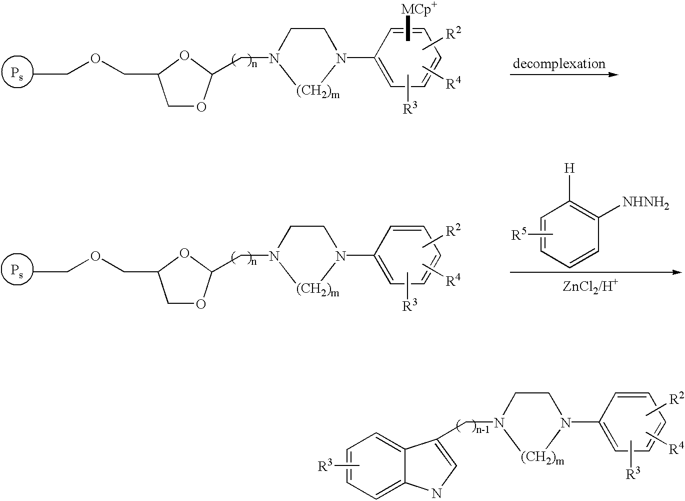

In a preferred embodiment of the above invention, n is 1-12, more preferred 2-6 and most preferred 3-5.

In another embodiment of the invention, the cleavage and simultaneous derivatisation are as demonstrated below:

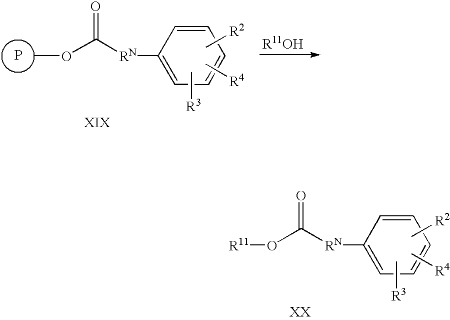

In the above example of simultaneous cleavage and derivatisation R^{N}, R²-R⁴ are as defined above and R¹¹ is alkyl, which is optionally further substituted by further substituents, with the proviso that R¹¹ is not substituted with other nucleophilic centres capable of reacting at the reaction centre.

One further embodiment of the invention is wherein the cleavage from the solid support is optionally followed by solution phase derivatisation:

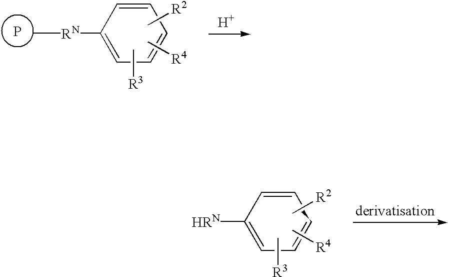

wherein R^{N}, R²-R⁴ are as defined above.

In the present example, the resulting secondary amines from the cleavage reaction from the polymer support, are suitable for further derivatisations by methods obvious to the chemist skilled in the art.

The reactions following the cleavage are standard reactions such as alkylation reactions on the primary or secondary amine, optionally in the cyclic amine according to the invention, which is a free amine after cleavage from the solid support. Alkylation reactions are performed by methods known in the art by halo-alkyl-derivatives. The halogen can be replaced by other leaving groups known in the art such as mesylates, triflates, or tosylates. In preferred embodiments of the invention, the halo-alkyl-derivative is a halo-alkyl-aryl-derivatives.

The cleavage from the solid support is performed according to literature procedures (Zaragoza, Tetrahedron Lett., 1995, 36, 8677-8678 and Conti et al., Tetrahedron Lett., 1997, 38, 2915-2918).

A suitable solid support could be a Merrifield resin or a solid supported carbamate group such as the Wang resin based carbamate linkier (Zaragoza, Tetrahedron Lett., 1995, 36, 8677-8678).

Definition of Substituents

The term halogen means fluoro, chloro, bromo or iodo.

The term alkyl refers to a branched or unbranched alkyl group having from one to eight carbon atoms inclusive, such as methyl, ethyl, 1-propyl, 2-propyl, 1-butyl, 2-butyl, 2-methyl-2-propyl, 2-methyl-1-propyl etc.

The term alkoxy refers to O-alkyl, wherein alkyl is as defined above.

The term alkylsulfanyl refers to S-alkyl, wherein alkyl is as defined above.

The term aryl refers to a mono- or bicyclic carbocyclic or heterocyclic aromatic group, such as phenyl, indolyl, thienyl, pryimidyl, oxazolyl, isoxazolyl, thiazolyl, isothiazolyl, imidazolyl, benzofuranyl, benzothienyl, pyridyl, naphtyl, furanyl, quinolinyl etc. Included are also non-aromatic carbocycles fused to the aryl-groups which optionally contain further heteroatoms such as benzodioxane, etc.

The term optional substituent refers to a substituent which does not interfere with the reaction sequence, ie. it does not contain other reactive nucleophile centres or other reactive sites, which will lead to side-reactions and consequently to the formation of side products. The optional substituents are also resistent to the standard procedures applied to the products in the remaining synthesis steps.

Starting Materials

For the reactions of the invention, the starting materials are obtained as follows:

\mathring{P} represents a polymer containing functional groups suitable for the linking of the solid phase synthesis intermediates, which is stable to the synthesis sequence applied, and liberates the product when the solid phase synthesis is finalised. Such polymers are known in the art and can be properly selected by the person skilled in the art. In the context of this invention, the polymer support is derivatised to the compound IV:

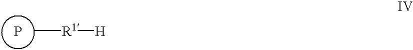

wherein R¹′ is as defined above, by applying either a synthesis sequence known to the chemist skilled in the art using commercially available starting materials, or the compound IV is commercially available.

The starting material of formula V, prepared in analogy to literature procedures (Pearson and Gelormani, J. Org. Chem. 1994, 59, 4561-4570), is reacted with the starting polymer support IV at elevated temperature in an aprotic solvent such as dry tetrahydrofuran using an appropriate base such as potassium carbonate.

The nucleophiles R³′H and R⁴′H are either commercially available, prepared by methods obvious to the chemist skilled in the art or according to literature procedures.

The starting polymer supports of formula XIII

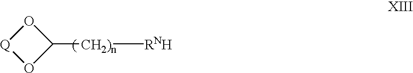

are prepared by the reaction of

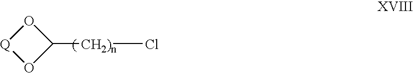

with an amine of formula HRNH which is defined above.

Polymer bound acetals of formula XVIII are prepared by reaction of aldehydes of formula Cl—(CH₂)ₙ₊₁—CHO with commercially available 2,2-dimethyl-1,3-dioxolan-4-yl-methoxymethyl polystyrene in a suitable solvent such as toluene, using p-toluenesulfonic acid as catalyst at elevated temperature. 4-Chlorobutanal, 5-chloropentanal, and 6-chlorohexanal are prepared in analogy to the method described by Norman, et al., Tetrahedron 1994, 50 (40), 11665.

### EXAMPLES

General methods: Melting points were determined on a Büchi SMP-20 apparatus and are uncorrected. Analytical LC-MS data were obtained on a PE Sciex API 10EX instrument equipped with IonSpray source and Shimadzu LC-8A/SLC-10A LC system. The LC conditions (50×4.6 mm YMC ODS-A with 5 μm particle size) were: Solventsystem: A=water/trifluoroacetic acid (100:0.05) and B=water/acetonitrile/trifluoroacetic acid (10:90:0.03). Methods: Method 1: Compounds were eluted by a linear gradient with A to B in 7 min at 2 ml/min. Method 2: The gradient program was 90% A to 40% in 4 min, 40% A to 10% in 2 min, 10% A to 0% A in 1 min, 0% A for 5 min at 2 ml/min. If not otherwise mentioned, method 1 was applied. Purity was determined by integration of the UV trace (254 nm). The retention times RT are expressed in minutes.

Preparative LC-MS-purification was performed on the same instrument. The LC conditions (50×20 mm YMC ODS-A with 5 μm particle size) were linear gradient elution with water/acetonitrile/trifluoroacetic acid (80:20:0.05) to water/acetonitrile/trifluoroacetic acid (10:90:0.03) in 7 min at 22.7 mL/min. Fraction collection was performed by split-flow MS detection.

¹H NMR spectra were recorded at 500.13 MHz on a Bruker Avance DRX500 instrument or at 250.13 MHz on a Bruker AC 250 instrument. Deuterated methylenchloride (99.8% D), chloroform (99.8% D) or dimethyl sulfoxide (99.8% D) were used as solvents. TMS was used as internal reference standard. Chemical shift values are expressed in ppm-values. The following abbreviations are used for multiplicity of NMR signals: s=singlet, d=doublet, t=triplet, q=quartet, qui=quintet, h=heptet, dd=double doublet, dt=double triplet, dq=double quartet, tt=triplet of triplets, m=multiplet and b=broad singlet. NMR signals corresponding to acidic protons are generally omitted. Content of water in crystalline compounds was determined by Karl Fischer titration.

For column chromatography, silica gel of type Kieselgel 60, 230-400 mesh ASTM was used. For ion-exchange chromatography, the following material was used: SCX-columns (1 g) from Varian Mega Bond Elut®, Chrompack cat. No. 220776. Prior to use, the SCX-columns were pre-conditioned with 10% solution of acetic acid in methanol (3 mL). For reversed phase chromatography, the following material was used: C-18 columns (1 g) from Varian Mega Bond Elut®, Chrompack cat. No. 220508). Prior to use the C-18-columns were pre-conditioned with methanol (3 mL) and water (3 mL). For decomplexation by irradiation, a ultraviolet light source (300 W) from Philipps was used. As starting polymer supports for solid phase synthesis, Wang-resin (1.03 mmol/g, Rapp-Polymere, Tuebingen, Germany) and (+/−)-1-(2,3-isopropylidene)glycerol polystyrene (1.40 mmol/g, Novabiochem, Laeufelfingen, Switzerland) were used.

### Example 1

### Preparation of Chloro-Substituted η⁶-aryl-η⁵-Cyclopentadienyliron(II) Hexafluorophosphates

1a, η⁶-2,6-Dichlorotoluene-η⁵-cyclopentadienyliron(II)hexafluorophosphate

Ferrocene (167 g), anhydrous aluminium trichloride (238 g) and powdered aluminium (24 g) were suspended in 1,3-dichlorotoluene (500 mL) and heated to 110° C. in a nitrogen atmosphere for 5 h with intensive stirring. The mixture was cooled to room temperature and water (1000 mL) was added carefully in small portions while cooling on an ice bath. Heptane (500 mL) and diethylether (500 mL) were added and the mixture was stirred at room temperature for 30 minutes. The mixture was extracted with diethylether (3×300 mL). The aqueous phase was filtered and aqueous ammonium hexafluorophosphate (60 g in 50 mL water) was added under stirring in small portions. The product was allowed to precipitate at room temperature overnight. The precipitate was filtered off and dried in vacuum (50° C.) to give 150 g (39%) of title compound as a light green powder. ¹H NMR (D₆-DMSO): 2.73 (s, 3H); 5.28 (s, 5H); 6.55 (t, 1H); 6.82 (d, 2H); LC/MS (m/z) 283 (M⁺-PF6), RT=1.53, purity: 96% (UV), 98% (ELSD). Anal. Calcd. for C₁₂H₁₂C₁₂F₆FeP: C, 33.68; H, 2.83. Found: C, 33.93; H, 2.63.

The following iron-complexes were prepared analogously:

1b, η⁶-1,2-Dichlorobenzene-η⁵-cyclopentadienyliron(II) hexafluorophosphate: ¹H NMR (D₆-DMSO): 5.29 (s, 5H); 6.48 (m, 2H); 7.07 (m, 2H); yield: 21%.

1c, η⁶-1,3-Dichlorobenzene-η⁵-cyclopentadienyliron(II) hexafluorophosphate: ¹H NMR (D₆-DMSO): 5.32 (s, 5H); 6.61 (t, 1H); 6.82 (d, 1H); 7.49 (s, 1H); yield: 11%.

1d, η⁶-1,4-Dichlorobenzene-η⁵-cyclopentadienyliron(II) hexafluorophosphate: 1H NMR (D₆-DMSO): 5.32 (s, 5H); 6.99 (s, 4H); yield: 31%.

1e, η⁶-1,2,3-Trichlorobenzene-η⁵-cyclopentadienyliron(II) hexafluorophosphate: ¹H NMR (D₆-DMSO): 5.38 (s, 5H); 6.61 (t, 1H); 7.09 (d, 2H); yield: 3.4%.

### Example 2

### Preparation of Polystyrene-Bound Amines

2a, 4-[(Piperazin-1-yl)carbonyloxymethyl]phenoxymethyl polystyrene

4-[(4-Nitrophenoxy)carbonyloxymethyl]phenoxymethyl polystyrene (267 g, 235 mmol) was suspended in dry N,N-dimethylformamide (2 L). N-Methylmorpholine (238.0 g, 2.35 mol) and piperazine (102.0 g, 1.17 mol) were added and the mixture was stirred at room temperature for 16 h. The resin was filtered off and washed with N,N-dimethylformamide (2×1 L), tetrahydrofuran (2×1 L), water (1×500 mL), methanol (2×1 L), tetrahydrofuran (2×1 L) and methanol (1×1 L). Finally, the resin was washed with dichloromethane (3×500 mL) and dried in vacuo (25° C., 36 h) to yield an almost colourless resin (240.0 g).

The following polystyrene bound diamines were prepared analogously

2b, 4-[(1,4-Diazepan-1-yl)carbonyloxymethyl]phenoxymethyl polystyrene

2c, 4-[(2,5-Dimethyl-piperazin-1-yl)carbonyloxymethyl]phenoxymethyl polystyrene

2d, 4-[(2-Methylaminoethyl)(methyl)aminocarbonyloxymethyl]phenoxymethyl polystyrene

2e, 4-[(3-Methylaminopropyl)(methyl)aminocarbonyloxymethyl]phenoxymethyl polystyrene

2f; 4-[(5-Methylamino-3-oxapentyl)(methyl)aminocarbonyloxymethyl]phenoxymethyl polystyrene

### Example 3

### Preparation of Resin-Bound η⁶-aryl-η⁵-cyclopentadienyliron(II) hexafluorophosphates

3a, 4-({4-[η⁶-2-Chlorophenyl)-η⁵-cyclopentadienyliron(II)]piperazin-1-yl}carbonyloxymethyl)phenoxymethyl polystyrene hexafluorophosphate

4-[(Piperazin-1-yl)carbonyloxymethyl]phenoxymethyl polystyrene (115.1 g, 92 mmol) was suspended in dry tetrahydrofuran (1.6 L) and η⁶-1,2-dichlorobenzene-η⁵-cyclopentadienyliron(II) hexafluorophosphate (76.0 g, 184 mmol) was added followed by potassium carbonate (50.9 g, 368 mmol). The reaction mixture was stirred at 60 ° C. for 16 h. After cooling to room temperature, the resin was filtered off and washed with tetrahydrofuran (2×500 mL), water (2×250 mL), tetrahydrofuran (2×500 mL), water (2×250 mL), methanol (2×250 mL), dichloromethane (2×250 mL) and methanol (2×250 mL). Finally, the resin was washed with dichloromethane (3×500 mL) and dried in vacuo (25° C., 36 h) to yield a dark orange resin (142 g).

The following polystyrene bound iron-complexes were prepared analogously:

3b, 4-({4-[η⁶-(3-Chloro-phenyl)-η⁵-cyclopentadienyliron(II)]piperazin-1-yl}carbonyloxymethyl)phenoxymethyl polystyrene hexafluorophosphate

3c, 4-({4-[η⁶-(4-Chloro-phenyl)-η⁵-cyclopentadienyliron(II)]piperazin-1-yl}carbonyloxymethyl)phenoxymethyl polystyrene hexafluorophosphate

3d, 4-({4-[η⁶-(2,3-Dichloro-phenyl)-η⁵-cyclopentadienyliron(II)]piperazin-1-yl}carbonyloxymethyl)phenoxymethyl polystyrene hexafluorophosphate

3e, 4-({4-[η⁶-(2-Methyl-3-chloro-phenyl)-η⁵-cyclopentadienyliron(II)]piperazin-1-yl}carbonyloxymethyl)phenoxymethyl polystyrene hexafluorophosphate

3f, 4-({4-[η⁶-(2-Chloro-phenyl)-η⁵-cyclopentadienyliron(II)]-[1,4]-diazepan-1-yl}carbonyloxymethyl)phenoxymethyl polystyrene hexafluorophosphate

3g, 4-({4-[η⁶-(3-Chloro-phenyl)-η⁵-cyclopentadienyliron(II)]-[1,4]-diazepan-1-yl}carbonyloxymethyl)phenoxymethyl polystyrene hexafluorophosphate

3h, 4-({4-[η⁶-(4-Chloro-phenyl)-η⁵-cyclopentadienyliron(II)]-[1,4]-diazepan-1-yl}carbonyloxymethyl)phenoxymethyl polystyrene hexafluorophosphate

3i, 4-({4-[η⁶-(2,3-Dichloro-phenyl)-η⁵-cyclopentadienyliron(II)]-[1,4]-diazepan-1-yl}carbonyloxymethyl)phenoxymethyl polystyrene hexafluorophosphate

3j, 4-({4-[η⁶-(2-Methyl-3-chloro-phenyl)-η⁵-cyclopentadienyliron(II)]-[1,4]-diazepan-1-yl}carbonyloxymethyl)phenoxymethyl polystyrene hexafluorophosphate

3k, 4-({(2-[η⁶-(2-Chloro-phenyl)-η⁵-cyclopentadienyliron(II)]methylaminoethyl)(methyl)amino}carbonyloxymethyl)phenoxymethyl polystyrene hexafluorophosphate

3l, 4-({(2-[η⁶-(3-Chloro-phenyl)-η⁵-cyclopentadienyliron(II)]methylaminoethyl)(methyl)amino}carbonyloxymethyl)phenoxymethyl polystyrene hexafluorophosphate

3m, 4-({(2-[η⁶-(4-Chloro-phenyl)-η⁵-cyclopentadienyliron(II)]methylaminoethyl)(methyl)amino}carbonyloxymethyl)phenoxymethyl polystyrene hexafluorophosphate

3n, 4-({(2-[η⁶-(2-Methyl-3-chloro-phenyl)-η⁵-cyclopentadienyliron(II)]methylaminoethyl)(methyl)amino}carbonyloxymethyl)phenoxymethyl polystyrene hexafluorophosphate

3o, 4-({(3-[η⁶-(2-Chloro-phenyl)-η⁵-cyclopentadienyliron(II)]methylaminopropyl)(methyl)amino}carbonyloxymethyl)phenoxymethyl polystyrene hexafluorophosphate

3p, 4-({(3-[η⁶-(3-Chloro-phenyl)-η⁵-cyclopentadienyliron(II)]methylaminopropyl)(methyl)amino}carbonyloxymethyl)phenoxymethyl polystyrene hexafluorophosphate

3q, 4-({(3-[η⁶-(4-Chloro-phenyl)-η⁵-cyclopentadienyliron(II)]methylaminopropyl)(methyl)amino}carbonyloxymethyl)phenoxymethyl polystyrene hexafluorophosphate

3r, 4-({(3-[η⁶(3-Chloro-2-methylphenyl)-η⁵cyclopentadienyliron(II)]methylaminopropyl)(methyl)amino}carbonyloxymethyl)phenoxymethyl polystyrene hexafluorophosphate

3s, 4-({(5-[η⁶(2-Chloro-phenyl)-η⁵-cyclopentadienyliron(II)]methylamino-3-oxapentyl)(methyl)amino}carbonyloxymethyl)phenoxymethyl polystyrene hexafluorophosphate

3t, 4-({(5-[η⁶-(3-Chloro-phenyl)-η⁵-cyclopentadienyliron(II)]methylamino-3-oxapentyl)(methyl)amino}carbonyloxymethyl)phenoxymethyl polystyrene hexafluorophosphate

3u, 4-({(5-[η⁶-(4-Chloro-phenyl)-η⁵-cyclopentadienyliron(II)]methylamino-3-oxapentyl)(methyl)amino}carbonyloxymethyl)phenoxymethyl polystyrene hexafluorophosphate

3v, 4-({(5-[η⁶-(2-Methyl-3-chloro-phenyl)-η⁵-cyclopentadienyliron(II)]methylamino-3-oxapentyl)(methyl)amino}carbonyloxymethyl)phenoxymnthyl polystyrene hexafluorophosphate

### Example 4

### A. N-aryl Diamines

A1. Nucleophilic Aromatic Substitution with Phenols, Thiophenols and Alkylmercaptanes

4aa, 1-[4-(2-Methoxyphenoxy)phenyl/piperazine

Nucleophilic Aromatic Substitution

To a solution of 4-hydroxyanisole (2.6 g, 20.9 mmol) in tetrahydrofuran (30 mL), sodium hydride (17.5 mmol; 60% in mineral oil) was carefully added at room temperature (Caution: Generation of hydrogen). The mixture was stirred for an additional 30 min after the generation of hydrogen had ceased. Subsequently, 4-({4-[η⁶(4-chloro-phenyl)-η⁵-cyclopentadienyliron(II)]piperazin-1-yl}carbonyloxymethyl)phenoxymethyl polystyrene hexafluorophosphate (5 g, 3.49 mmol) was added and the mixture was stirred at 40° C. for 12 h. After cooling to room temperature, the resin was filtered off and washed with tetrahydrofuran (2×50 mL), tetrahydrofuran/water (1:1) (2×50 mL), N,N-dimethylformamide (2×50 mL), water (2×50 mL), methanol (3×50 mL), tetrahydrofuran (3×50 mL), and subsequently with methanol and tetrahydrofuran (each 50 mL, 5 cycles). Finally, the resin was washed with dichloromethane (3×50 mL) and dried in vacuo (25° C., 12 h) to yield a dark orange resin.

Decomplexation

The thus obtained resin and a 0.5 M solution of 1,10-phenanthroline in 3:1 mixture of pyridine/water (20 mL) was placed in light-transparent reactor tube. The suspension was agitated by rotation under irradiation with visible light for 12 h. The resin was filtered and washed with methanol (2×25 mL), water (2×25 mL) and tetrahydrofuran (3×25 mL) until the washing solutions was colourless (approx. 5 cycles) and the irradiation procedure was repeated until decomplexation was complete (approx. 5 cycles). After the decomplexation was completed, the resin was washed with dichlormethane (3×25 mL) and dried in vacuo (25° C., 12 h) to obtain a light brown resin (approximately 3.6 g, 2.81 mmol).

Cleavage

The resin was suspended in a 1:1 mixture of trifluoroacetic acid and dichlormethane (10 mL) and stirred at room temperature for 2 h. The resin was filtered off and washed with methanol (1×5 mL) and dichloromethane (1×5 mL). The combined organic phases were carefully and slowly added to an 4 N aqueous sodium hydroxide solution (20 mL) keeping the temperature between −5 and 5° C. After complete addition, the mixture was stirred 30 min and extracted with ethyl acetate (3×100 mL). The combined organic extracts were washed with brine and dried over magnesium sulfate. After evaporation of the volatile solvents in vacuum, a yellow oil was obtained (267 mg, purity: 70% by LC-MS and UV-detection). Finally the crude product was purified by flash-chromatography (acetone/triethylamine 10:1) to yield the title compound as an almost colourless solid. 123 mg (12% overall yield after 6 steps and purification starting from commercially available Wang-resin). Mp: 141-142° C. (acetone/heptane). ¹H NMR (CD₂Cl₂): 3.16 (m, 8H); 3.88 (s, 3H); 3.82-6.98 (m, 7H); 7.06 (d, 1H); 7.15 (m, 1H). ¹³C-NMR (CD₂Cl₂): 46.1, 50.9, 56.6, 113.6, 118.8, 118.9, 120.9, 121.7, 125.0, 146.7, 148.1, 152.0, 152.3. LC/MS (m/z) 285 (MH⁺), RT=2.91, purity (after flash-chromatography): 85% (UV), 98% (ELSD). The following arylpiperazines were prepared analogously:

4ac, 1-[3-(2-Methoxyphenoxy)phenyl]piperazine. ¹H NMR (CD₂Cl₂): 2.93 (m, 4H); 3.15 (m, 4H); 3.88 (s, 3H); 6.78 (d, 1H); 6.84-6.95 (m, 3H); 7.03-7.08 (m, 3H); 7.13 (t, 1H). LC/MS (m/z) 285 (MH⁺), RT=3.00, purity (after flash-chromatography, UV): 86%, yield: 12%.

4ad, 1-[2-Methyl-3-(3-dimethylaminophenoxy)phenyl]piperazine: ¹H NMR (d₆-DMSO): 2.15 (s, 3H), 2.89 (s, 6H), 3.06 (m, 4H), 3.28 (m, 4H), 6.10 (d, 1H), 6.34 (s, 1H), 6.50 (d, 1H), 6.58 (d, 1H), 6.89 (d, 1H), 7.11 (t, 1H), 7.19 (t, 1H). LC/MS (m/z) 312 (MH⁺), RT=2.52, purity (after cleavage, UV): 97%; yield: 11%. Mp: 174-177 ° C. (acetone/heptane).

4ae, 1-[2-(2,6-Dimethoxyphenoxy)phenyl]-[1,4]-diazepane: ¹H NMR (CD₂Cl₂): 2.21 (m, 2H); 3.42 (m, 4H); 3.44 (t, 2H); 3.65 (m, 2H); 3.77 (s, 6H), 6.39 (d, 1H); 6.72 (d, 2H); 6.74 (m, 1H); 6.92 (m, 1H); 7.02 (d, 1H); 7.20 (t, 1H). LC/MS (m/z) 285 (MH⁺), RT=3.33, purity (UV): 85%, yield: 14%. Mp: 193-195° C. (acetone/heptane).

4ag, 1-[3-(4-Methylphenylsulfanyl)phenyl]piperazine: ¹H NMR (CD₂Cl₂): 2.37 (s, 3H); 3.17 (m, 4H); 3.25 (m, 4H); 6.25 (b, 1H); 6.81 (m, 2H); 6.91 (s, 1H); 7.18 (m, 3H); 7.35 (d, 2H). LC/MS (m/z) 285 (MH⁺), RT=3.71, purity (UV): 85%; yield: 15%.

4ah, 1-[4-(4-Methylphenysulfanyl)phenyl]piperazine: ¹H NMR (CD₂Cl₂): 2.31 (s, 3H); 3.02 (m, 4H); 3.19 (m, 4H); 6.90 (d, 2H); 7.09 (d, 2H); 7.13 (d, 2H); 7.34 (d, 2H). LC/MS (m/z) 285 (MH⁺), RT=3.71, purity (UV): 90%; yield: 13%.

4ai, 1-[2-(Cyclohexylsulfanyl)phenyl]piperazine: ¹H NMR (CD₂Cl₂): 1.3-1.5 (m, 5H); 1.7 (m, 11H); 1.86 (m, 2H); 2.05 (m, 2H); 3.10 (m, 4H); 3.16 (m, 4H); 3.33 (m, 11H); 5.44 (b, 11H); 7.08 (m, 2H); 7.19 (t, 11H); 7.31 (d, 1IH). LC/MS (m/z) 277 (MH⁺), RT=3.62, purity (UV): 90%; yield: 16%.

4aj, 1-[3-(Cyclohexylsulfanyl)phenyl]piperazine: ¹H NMR (CD₂Cl₂): 1.2-1.5 (m, 5H); 1.67 (m, 1H); 1.81 (m, 2H); 2.05 (m, 2H); 3.04 (m, 4H); 3.13 (m, 5H); 6.80 (d, 1H); 6.89 (d, 1H); 6.96 (s, 11H); 7.20 (t, 11H). LC/MS (m/z) 277 (MH⁺), RT=3.74, purity (UV): 91%; yield: 11%.

4ak, 1-[4-(Cyclohexylsulfanyl)phenyl]piperazine: ¹H NMR (CD₂Cl₂): 1.2-1.5 (m, 5H); 1.62 (m, 1H); 1.80 (m, 2H); 1.95 (m, 2H); 2.91 (m, IH); 3.01 (m, 4H); 3.15 (m, 4H); 6.88 (d, 2H); 7.36 (d, 2H). LC/MS (m/z) 277 (MH⁺), RT=3.71, purity (after flash-chromatography, UV): 91%; yield: 15%. Mp: 178-180° C. (acetone/heptane).

A2. Nucleophilic Aromatic Substitution with Alkyl Alcoholates

4ba, 1-[2-(2-Ethoxyethoxy)phenyl]piperazine

To a solution of 2-ethoxyethanol (1.57 g, 17.4 mmol) in tetrahydrofuran (30 ml) was carefully added sodium hydride (17.5 mmol; 60% in mineral oil) at room temperature (Caution: Generation of hydrogen). The solution was then cooled to −20° C. and 4-({4-[η⁶-(2-chloro-phenyl)-η⁵-cyclopentadienyliron(II)]piperazin-1-yl}carbonyloxymethyl)phenoxymethyl polystyrene hexafluorophosphate (5 g, 3.49 mmol) was added. After 15 min, the mixture was slowly warmed up to room temperature and was stirred for further 1.5 h. The resin was filtered off and washed with tetrahydrofuran (2×50 mL), tetrahydrofuran/water (1:1) (2×50 mL), N,N-dimethylformamide (2×50 mL), water (2×50 mL), methanol (3×50 mL), tetrahydrofuran (3×50 mL), and subsequently with methanol and tetrahydrofuran (each 50 mL, 5 cycles). Finally, the resin was washed with dichloromethane (3×50 mL) and dried in vacuo (25° C., 12 h) to yield an orange resin. The subsequent procedure for decomplexation, cleavage and working-up followed the protocol described above. The crude product was purified by flash-chromatography (acetone/ triethylamine 10:1) to yield the title compound as a slightly yellow oil. 47 mg (5%, overall yield after 6 steps and purification starting from commercially available Wang-resin). ¹H NMR (CD₂Cl₂): 1.28 (t, 3H); 3.04 (m, 8H); 3.49 (q, 2H); 3.81 (t, 2H); 4.12 (t, 2H); 6.88 (d, 1H); 6.9-7.0 (m, 3H). LC/MS (m/z) 251 (MH⁺), RT=2.30, purity (UV): 71%.

The following arylpiperazines were prepared analogously:

4bb, 1-[3-(2-Ethoxyethoxy)phenyl]piperazine: oil. ¹H NMR (CD₂Cl₂): 1.24 (t, 3H); 3.03 (m, 4H); 3.14 (m, 4H); 3.59 (q, 2H); 3.78 (t, 2H); 4.11 (t, 2H); 6.44 (d, 1H); 6.50 (s, 1H); 6.55 (d, 1H); 7.04 (t, 11H). LC/MS (m/z) 251 (MH⁺), RT=2.28, purity (UV): 86%; yield: 8%.

4bc, 1-[4-(2-Ethoxyethoxy)phenyl]piperazine: oil. ¹H NMR (CD₂Cl₂): 1.25 (t, 3H); 3.05 (m, 8H); 3.60 (q, 2H); 3.78 (t, 2H); 4.08 (t, 2H); 6.89 (dd, 4H). LC/MS (m/z) 251 (MH⁺), RT=2.10, purity (UV): 68%; yield: 6%.

A3. Nucleophilic Aromatic Substitution with Amines

4ca, 1-[3-(Morpholin-4-yl)phenyl]piperazine

A mixture of 4-({4-[η⁶-(3-chloro-phenyl)-η⁵-cyclopentadienyliron(II)]piperazin-1-yl}carbonyloxymethyl)phenoxymethyl polystyrene hexafluorophosphate (5 g, 3.49 mmol) morpholine (1.49 g, 17.9 mmol) and potassium carbonate (2.36 g, 17.1 mmol) in tetrahydrofuran (30 mL) was shaked at 40° C. for 12 h. After cooling to room temperature, the resin was filtered off and washed with tetrahydrofuran (2×50 mL), tetrahydrofuran/water (1:1) (2×50 mL), water (4×50 mL), N,N-dimethylformamide (2×50 mL), water (2×50 mL), methanol (3×50 mL), tetrahydrofuran (3×50 mL), and subsequently with methanol and tetrahydrofuran (each 50 mL, 5 cycles). Finally, the resin was washed with dichloromethane (3×50 mL) and dried in vacuo (25° C., 12 h) to yield a dark orange resin. The subsequent procedure for decomplexation, cleavage and working-up followed the protocol described above.

The crude product (185 mg) was purified by flash-chromatography (acetone/triethylamine 10:1) to yield the title compound as slightly yellow oil. 144 mg (0.58 mmol; 17%, overall yield after 6 steps and purification starting from commercially available Wang-resin). ¹H NMR (CD₂Cl₂): 3.03 (m, 4H); 3.15 (m, 8H); 3.84 (m, 4H); 6.47 (m, 2H), 7.16 (t, IH). LC/MS (m/z) 248 (MH⁺), RT=1.34, purity (UV): 87%.

The following arylpiperazines were prepared analogously:

4cb, 1-[4-(Morpholin-4-yl)phenyl]piperazine: ¹H NMR (CD₂Cl₂): 3.05 (m, 12H); 3.84 (m, 4H); 6.90 (m, 4H). LC/MS (m/z) 248 (MH⁺), RT=0.72, purity (UV): 58%; yield: 15%.

4cc, 1-{[2-Methyl-3-(morpholin-4-yl)]phenyl}piperazine: ¹H NMR (D₆-DMSO): 2.15 (s, 3H); 2.89 (s, 6H); 3.06 (m, 4H); 3.28 (m, 4H); 6.10 (d, 1H); 6.34 (s, 1H); 6.50 (d, 1H), 6.58 (d, 1H), 6.89 (d, 1H); 7.11 (t, 1H); 7.19 (t, 1H); 6.58 (d, 1H); 3.06. LC LC/MS (m/z) 312 (MH⁺), RT=2.57, purity (after flash-chromatography, UV): 89%; yield: 5%; Mp: 205-206° C. (acetone/heptane, free base)

A4. Nucleophilic Aromatic Substitution with Selenides

4da, 1-(3-Phenylselenylphenyl)piperazine

Sodium borohydride (0.52 g, 13.6 mmol) was added in small portions to a solution of diphenyldiselenide (4.28 g, 13.7 mmol) in ethanol (10 mL) at room temperature. After stirring for 2 h, tetrahydrofuran (40 mL) and subsequently 4-{4-[η⁶-(4-chlorophenyl)-η⁵-cyclopentadienyliron(II)]piperazin-1-yl }carbonyloxymethyl)phenoxymethyl polystyrene hexafluorophosphate (5 g, 3.49 mmol) were added. The mixture was stirred at room temperature for 16 h. The resin was filtered off and washed with tetrahydrofuran (2×50 mL), tetrahydrofuran/water (1:1) (2×50 mL), N,N-dimethylformamide (2×50 mL), water (1×50 mL), methanol (3×50 mL), tetrahydrofuran (3×50 mL), and subsequently with methanol and tetrahydrofuran (each 50 mL, 5 cycles). Finally, the resin was washed with dichloromethane (3×50 mL) and dried in vacuo (25° C., 12 h) to yield an intensively yellow resin. The subsequent procedure for decomplexation, cleavage and working-up followed the protocol described above.

The crude product was purified by flash-chromatography (acetone/ triethylamine 10:1) to yield the title compound as an almost colourless solid. 354 mg (32% overall yield after 6 steps and purification starting from commercially available Wang-resin). Mp: 120-122 ° C. (re-crystallized from acetone/heptane). ¹H NMR (CD₂Cl₂): 3.05 (m, 4H); 3.20 (m, 4H); 6.90 (d, 1H); 7.04 (d, 1H); 7.15 (s, 1H), 7.24 (t, 1H); 7.35 (m, 3H), 7.55 (m, 2H). ¹³C-NMR (CD₂Cl₂): 46.1, 49.9, 116.0, 121.3, 125.1, 128.1, 130.1, 130.7, 132.2, 132.4, 133.5, 153.0. LC/MS (m/z) 319 (M+2H⁺), RT=3.44, purity: 90% (after flash-chromatography, UV), 99% (ELSD).

The following arylpiperazine was prepared analogously:

4db, 1-(2-Methyl-3-phenylselenylphenyl)piperazine: ¹H NMR (CD₂Cl₂): 2.42 (s, 3H); 3.15 [m, 4H]; 3.37 [m, 4H]; 7.02 (t, 1H); 7.09 (d, 2H); 7.32 (m, 3H), 7.47 (m, 2H). LC/MS (m/z) 319 (M+2H⁺), RT=3.78, purity: 93% (after flash-chromatography, UV), yield: 24%; Mp: 155-156° C. (acetone/heptane)

### Example 5

### B. N-Alkyl, N′-aryl-diamines

5a, 1-[2-(2-Methoxyphenoxy)phenyl]-4-[3-(]H-indol-3-yl)propyl]piperazine

4-[(Piperazin-1-yl)carbonyloxymethyl]phenoxymethyl polystyrene (115.1 g, 92 mmol) was suspended in dry tetrahydrofuran (1.6 L) and η⁶-1,2-dichlorobenzene-η₅-cyclopentadienyliron(II) hexafluorophosphate (76.0 g, 184 mmol) was added followed by potassium carbonate (50.9 g, 368 mmol). The reaction mixture was stirred at 60 ° C. for 16 h. After cooling to room temperature, the resin was filtered off and washed with tetrahydrofuran (2×500 mL), water (2×250 mL), tetrahydrofuran (2×500 mL), water (2×250 mL), methanol (2×250 mL), dichloromethane (2×500 mL), methanol (2×250 mL). Finally, the resin was washed with dichloromethane (3×500 mL) and dried in vacuo (25° C., 36 h) to yield a dark orange resin (142 g).

To a solution of 2-hydroxyanisole (2.2 g, 17.7 mmol) in tetrahydrofuran (50 mL) was carefully added sodium hydride (15.5 mmol, 60% in mineral oil) at room temperature (Caution: Generation of hydrogen). The mixture was stirred additional 30 min after the generation of hydrogen stopped. Subsequently, a part of the above obtained resin (2.8 g, 1.72 mmol) was added and the mixture was stirred at 40° C. for 12 h. After cooling to room temperature, the resin was filtered off and washed with tetrahydrofuran (2×50 mL), tetrahydrofuran/water (1:1) (2×50 mL), N,N-dimethylformamide (2×50 mL), water (2×50 mL), methanol (3×50 mL), tetrahydrofuran (3×50 mL), and subsequently with methanol and tetrahydrofuran (each 50 mL, 5 cycles). Finally, the resin was washed with dichloromethane (3×50 mL) and dried in vacuo (25° C., 12 h).

The thus obtained resin (3.0 g, 1.84 mmol) and a 0.5 M solution of 1,10-phenanthroline in a 3:1 mixture of pyridine/water (20 mL) was placed in a light-transparent reactor tube. For decomplexation, the suspension was agitated by rotation and irradiated with visible light for 12 h. The resin was filtered and washed with methanol (2×25 mL), water (2×25 ml) and tetrahydrofuran (3×25 mL) until the washing solutions kept colourless (approx. 5 cycles) and the irradiation procedure was repeated until decomplexation was complete (approx. 5 cycles). After complete decomplexation, the resin was washed with dichloromethane (3×25 mL) and dried in vacuo (25° C., 12 h).

The resin (2.5 g, 1.84 mmol) was suspended in a 1:1 mixture of trifluoroacetic acid and dichloromethane (25 mL) and stirred at room temperature for 2 h. The resin was filtered off and washed with methanol (1×5 mL) and dichloromethane (1×5 mL). The combined liquid phases were collected and the volatile solvents were evaporated in vacuo to yield a dark brown oil (1.5 g)

The oil was dissolved in acetonitril (10 mL). To the thus obtained solution potassium carbonate (46 mg, 0.33 mmol) and 3-(3-bromopropyl)-1H-indole (33 mg, 0.14 mmol) were added and the mixture was heated at 70° C. for 12 h. Isocyanatomethyl polystyrene (250 mg, 0.29 mmol) was added and the mixture was slowly cooled to room temperature. The resin was filtered off and washed with methanol (1×2 mL) and dichloromethane (1×2 mL). The combined organic phases were collected and the volatile solvents were evaporated in vacuo to yield a dark brown oil. The crude product was purified by preparative reversed phase HPLC chromatography. The collected fractions were subsequently loaded on a pre-conditioned ion exchange column. The column was washed with methanol (4 mL) and acetonitrile (4 mL), followed by elution of the product with 4 N solution of ammonia in methanol (4.5 mL). Evaporation of the volatile solvents afforded the title compound 5a as yellow oil (66 mg, 0.14 mmol, 100%). LC/MS (m/z) 442 (MH+), Rt=4.15, purity: 93%.

The following compounds were prepared analogously:

5b, 1-(2-Phenoxyphenyl)-4-[4-(]H-indol-3-yl)butyl/piperazine: LC/MS (m/z) 426 (MH⁺), RT=4.36, purity: 79%.

5c, 1-[2-(1,3-Benzodioxolan-5-yloxy)phenyl]-4-[4-(1H-indol-3-yl)butyl]piperazine: LC/MS (m/z) 470 (MH⁺), RT=2.62, purity: 89%.

5d, 1-[2-(2-Methoxyphenoxy)phenyl]-4-[2-(6-chloro-1H-indol-3-yl)ethyl]piperazine:LC/MS (m/z) 462 (MH⁺), RT=4.35, purity: 76%.

5e, 1-[2-(1,3-Benzodioxolan-5-yloxy)phenyl]-4-[2-(6-chloro-1H-indol-3-yl)ethyl]-piperazine: LC/MS (m/z) 476 (MH⁺), RT=2.64, purity: 89%.

5f 1-2-[3-(Dimethylamino)phenoxy]phenyl)-4-[2-(6-chloro-1H-indol-3-yl)ethyl]-piperazine: LC/MS (m/z) 475 (MH⁺), RT=2.32, purity: 91%.

5g, 1-[2-(2-Methoxyphenoxy)phenyl]-4-[4-(1H-indol-3-yl)butyl]piperazine: LC/MS (m/z) 456 (MH⁺), RT=4.31, purity: 90%.

5h, 1-[2-(4-Methoxyphenoxy)phenyl]-4-[3-(1H-indol-3-yl)propyl]piperazine. LC/MS (m/z) 442 (MH⁺), RT=4.18, purity: 90%.

5i, 1-(2-[3-(Dimethylamino)phenoxy]phenyl)-4-[4-(1H-indol-3-yl)butyl]piperazine: LC/MS (m/z) 469 (MH⁺), RT=2.27, purity: 88%.

5j, 1-(2-Phenoxyphenyl)-4-[2-(6-chloro-1H-indol-3-yl)ethyl]piperazine: LC/MS (m/z) 432 (MH⁺), RT=4.40, purity: 70%.

5k, 1-{4-[3-(1H-indol-3-yl)propyl]piperazinyl)-benzo[b]naphtho[2, 3-e][1, 4]dioxine: ¹H NMR (CDCl₃): 2.00 (qui, 2H); 2.57 (t, 2H); 2.76 [m, 4H], 2.83 (t, 2H), 3.19 [m, 4H]; 6.62 (t, 2H); 6.88 (t, 1H); 7.00 (s, 1H); 7.10 (t, 1H); 7.20 (t, 1H); 7.23 (s, 1H); 7.28 (s, 1H); 7.31 (m, 2H), 7.36 (d, 1H); 7.62 (m, 3H); 7.95 (b, 1H). LC/MS (m/z) 476 (MH⁺), RT=9.61 (Methode 2), purity: >85%.

5l, 1-[2,6-Di(4-methylsulanylphenylsulfanyl)phenyl]-4-[(1H-indol-3-yl)propyl]piperazine: ¹H NMR (CDCl₃): 1.90 (qui, 2H); 2.41 [m, 9H); 2.49 (s, 3H); 2.79 (t, 2H), 3.01 [m, 4H]; 6.50 (d, 1H); 6.85 (d, 1H); 6.97 (s, 1H); 7.02 (d, 2H); 7.11 (m, 4H); 7.19 (t, 1H); 7.21 (d, 2H); 7.35 (m, 3H); 7.60 (d, 1H); 7.90 (b, 1H). LC/MS (m/z) 628 (MH⁺), RT=10.51 (Methode 2), purity: >85%.

5n, 1,4-Dimethyl-5-([4-(1H-indol-3-yl)butyl]piperazinyl}benzo[1,4]diazinane: ¹H NMR (CDCl₃): 1.68 (m, 2H), 1.78 (qui, 2H), 2.46 (m, 2H), 2.80 (t, 2H), 2.82 (s, 3H), 2.92 (s, 3H), 3.09 (m, 2H), 3.12 (m, 2H), 3.19 (m, 4H), 6.36 (d, 1H), 6.44 (d, 1H), 6.83 (t, 1H); 6.99 (s, 1H), 7.10 (t, 1H), 7.19 (t, 1H), 7.35 (d, 1H), 7.60 (d, 1H), 7.90 (d, 1H); LC/MS (m/z) 418 (MH⁺), RT=1.79, purity: 68%.

5p, 1-{3-[(5-{([2-(6-chloro-1H-indol-3-yl)ethyl]methylamino}-3-oxapent-1-yl)methylamino] phenyl}-4-(pyrrolidinocarbonylmethyl)piperazine: ¹H NMR (CDCl₃): 1.88 (qui, 2H); 1.98 (qui, 2H); 2.48 (s, 3H); 2.6-2.8 (m, 8H); 2.89 (t, 2H); 2.92 (s, 3H); 3.19 (m, 6H); 3.45-3.65 (m, 10H); 6.27 (m, 2H); 6.31 (d, 1H); 7.00 (s, 1H); 7.04 (d, 1H); 7.10 (t, 1H); 7.31 (s, 1H); 7.48 (d, 1H); 8.44 (b, 1H).

5q, 1-(3-[(5-{[3-(1H-indol-3-yl)propyl]methylamino)-3-oxa-pent-1-yl)methylamino]phenyl}-4-(pyrrolidinocarbonylmethyl)piperazine: ¹H NMR (CDCl₃): 1.8-2.2 (m, 6H); 2.9 (s, 3H); 2.49 (t, 2H); 2.58 (t, 2H); 2.70 (m, 4H); 2.78 (t, 2H); 2.95 (s, 3H); 3.15 (s, 2H); 3.20 (m, 4H); 3.41-3.55 (m, 8H); 3.59 (t, 2H); 6.28 (m, 2H); 6.31 (d, 1H); 6.97 (s, 1H); 7.09 (m, 2H); 7.18 (t, 1H); 7.34 (d, 1H); 7.60 (d, 1H); 8.20 (,b, 1H).

5r, 1-{3-[(3-{[4-(1-H-indol-3-yl)butyl]methylamino}-prop-1-yl)methylamino]phenyl}-4-(pyrrolidinocarbonylmethyl)piperazine: ¹H NMR (CDCl₃): 1.55 (m, 2H); 1.71 (m, 4H); 1.86 (qui, 2H); 1.93 (qui, 2H); 2.19 (s, 3H); 2.35 (q, 4H); 2.72 (m, 4H); 2.79 (t, 2H); 2.89 (s, 3H); 3.17 (s, 2H); 3.21 (m, 4H); 3.31 (t, 2H); 3.03 (t, 4H); 6.20-3.35 (m, 3H); 6.95 (s, 1H); 7.10 (m, 2H); 7.18 (t, 1H); 7.33 (d, 1H); 7.60 (d, 1H); 8.26 (b, 1H).

5s, 1-{3-[(3-{[3-(6-chloro-1H-indol-1-yl)propyl]methylamino}-prop-1-yl)methylamino]phenyl}-4-(pyrrolidinocarbonylmethyl)piperazine. ¹H NMR (CDCl₃): 1.70 (qui, 2H); 1.85 (qui, 2H), 1.95 (qui, 4H); 2.18 (s, 3H); 2.18 (t. 3H); 3.31 (t, 3H); 2.70 (m, 4H); 2.79 (s, 3H); 3.18 (s, 2H); 3.21 (m, 4H); 3.31 (t, 2H); 3.50 (t, 4H); 4.15 (t, 3H); 6.20-6.35 (m, 3H); 6.40 (s, 1H); 7.05-7.16 (m, 3H); 7.27 (m, 1H); 7.17 (s, 1H).

### Example 6

### C. Indole Formation Upon Cleavage from the Polymer Support

6a, 1-[2-(1, 4-Benzodioxan-5-yloxy)phenyl]-4-[3-(5-fluoro-1H-indol-3-yl)propyl]piperazine

2-(3-Chlorobutyl)-1,3-dioxolan-4-ylmethoxymethyl polystyrene (70 g, 90.3 mmol) was suspended in dry N,N-dimethylformamide (700 mL). Sodium iodide (68 g, 452 mmol) was added followed by diisopropylethylamine (232 mL, 1.36 mol) and piperazine (117 g, 1.36 mol). The reaction mixture was heated at 80° C. under stirring for 12 h. After cooling to room temperature, the resin was filtered off and washed with N,N-dimethylformamide (3×500 mL), methanol (3×500 mL), tetrahydrofuran (3×500 mL), and subsequently with methanol and tetrahydrofuran (each 250 mL, 5 cycles). Finally, the resin was washed with dichloromethane (3×500 mL) and dried in vacuo (25° C., 36 h) to yield an almost colourless resin (76 g).

A part of the obtained resin (50 g, 60.6 mmol) was then suspended in dry tetrahydrofuran (600 mL). η⁶-1,2-Dichlorobenzene-η⁵-cyclopentadienyliron(II) hexafluorophosphate (48 g, 116.2 mmol) was added followed by potassium carbonate (32 g, 233 mmol). The reaction mixture was stirred at 60° C. for 12 h. After cooling to room temperature, the resin was filtered off and washed with tetrahydrofuran (2×500 mL), water (2×250 mL), tetrahydrofuran (2×500 mL), methanol (2×250 mL), dichloromethane (2×500 mL), methanol (2×250 mL). Finally, the resin was washed with dichloromethane (3×500 mL) and dried in vacuo (25° C., 36 h) to yield a dark orange resin (70 g).

To a solution of 5-hydroxy-1,4-benzodioxane (2.8 g, 18.4 mmol) in tetrahydrofuran (50 mL) was carefully added neat sodium hydride (15.5 mmol) at room temperature (Caution: Generation of hydrogen). The mixture was stirred for an additional 30 min after the generation of hydrogen ceased. Subsequently, a part of the above obtained resin (2.8 g, 2.3 mmol) was added and the mixture was stirred at 40° C. for 12 h. After cooling to room temperature, the resin was filtered and washed with tetrahydrofuran (2×50 mL), tetrahydrofuran/water (1:1) (2×50 mL), N,N-dimethylformamide (2×50 mL), water (2×50 mL), methanol (3×50 mL), tetrahydrofuran (3×50 mL), and subsequently with methanol and tetrahydrofuran (each 50 mL, 5 cycles). Finally, the resin was washed with dichloromethane (3×50 mL) and dried in vacuo (25° C., 12 h).

A part of the obtained resin (200 mg, 0.15 mmol) and a 0.5 M solution of 1,10-phenanthroline in a (3:1)-mixture of pyridine/water (10 mL) was placed in a light-transparent reactor tube. The suspension was vortexed and irradiated for 12 h. A very characteristic feature of the decomplexation step is the appearance of the intensive red colour of the liquid phase during irradiation. The resin was filtered and washed with methanol (2×10 mL), water (2×10 ml) and tetrahydrofuran (3×10 mL) until the washing solutions kept colourless (approx. 5 cycles) and the irradiation procedure was repeated until decomplexation was complete (approx. 4 cycles). After complete decomplexation, the resin was washed with dichloromethane (3×10 mL) and dried in vacuo (25° C., 12 h).

The obtained resin (160 mg, 0.15 mmol) and 4-fluorophenylhydrazine hydrochloride (35 mg, 0.21 mmol) were mixed in a reactor tube. A 0.5 M solution of anhydrous zinc chloride in acetic acid (1.5 mL) was added and the reaction tube was sealed. The reaction mixture was stirred for 12 h at 70° C. After cooling to room temperature, the reaction mixture was filtered and the residual resin washed with dimethyl sulfoxide (1.5 mL). To the combined filtrates was added saturated aqueous sodium carbonate solution (1.5 mL) carefully (Caution: Generation of carbon dioxide). The solution was loaded on a pre-conditioned reversed phase C-18 column. The column was washed with water (4 mL) and the product was eluted with methanol (4.5 mL). After evaporation of the volatile solvents, the crude product was purified by preparative reversed phase HPLC chromatography. The resulting solution was subsequently loaded on a pre-conditioned ion exchange column. The column was washed with methanol (4 mL) and acetonitrile (4 mL), followed by elution of the product with 4 N solution of ammonia in methanol (4.5 mL). Evaporation of the volatile solvents afforded the title compound 5a as yellow oil (2 mg, 4.1 μmol). LC/MS (m/z) 488 (MH³⁰ ), Rt=4.22, purity: 84%.

The following compounds were prepared analogously:

6b, 1-(2-Phenoxyphenyl)-4-[3-(5-methyl-1H-indol-3-yl)propyl]piperazine.: LC/MS (m/z) 426 (MH⁺), RT=4.44, purity: 88%.

6c, 1-[2-(2-Methoxyphenoxy)phenyl]-4-[3-(5-chloro-1H-indol-3-yl)propyl]piperazine: LC/MS (m/z) 476 (MH⁺), RT=4.46, purity: 95%.

6d, 1-[2-(2-Methoxyphenoxy)phenyl]-4-[3-(5-bromo-1H-indol-3-yl)propyl]piperazine: LC/MS (m/z) 522 (MH⁺), RT=4.52, purity: 91%.

6e, 1-(2-Phenoxyphenyl)-4-[3-(1H-indol-3-yl)propyl]piperazine: LC/MS (m/z) 412 (MH⁺), RT=4.25, purity: 98%.

6f; 1-(2-Phenoxyphenyl)-4-[3-(5-fluoro-1H-indol-3-yl)propyl]piperazine LC/MS (m/z) 430 (MH⁺), RT=4.32, purity: 96%.

6g, 1-(2-Phenoxyphenyl)-4-[3-(5-bromo-1H-indol-3-yl)propyl]piperazine: LC/MS (m/z) 492 (MH⁺), RT=4.60, purity: 84%.

6h, ]-[2-(2, 6-Dimethoxyphenoxy)phenyl]-4-[3-(5-bromo-1H-indol-3-yl)propyl]piperazine: LC/MS (m/z) 552 (MH⁺), RT=4.49, purity: 86%.

6i, 1-{2-[3-(Dimethylamino)phenoxy]phenyl}-4-[3-(5-methyl-1H-indol-3-yl)propyl]piperazine: LC/MS (m/z) 469 (MH⁺), RT=3.73, purity: 86%.

6j, 1-(2-Phenoxyphenyl)-4-[3-(5-chloro-1H-indol-3-yl)propyl]piperazine: LC/MS (m/z) 446 (MH⁺), RT=4.52, purity: 88%.

6k, 1-[2-(1, 3-Benzodioxolan-5-yloxy)phenyl]-4-[3-(5-methyl-1H-indol-3-yl)propyl]piperazine: LC/MS (m/z) 470 (MH⁺), RT=4.38, purity: 70%.

6l, 1-[2-(2-Methoxyphenoxy)phenyl]-4-[3-(5-fluoro-1H-indol-3-yl)propyl]piperazine: LC/MS (m/z) 460 (MH⁺), RT=4.24, purity: 87%.

6m, 1-[2-(2-Methoxyphenoxy)phenyl]-4-[3-(7-chloro-1H-indol-3-yl)propyl]piperazine: LC/MS (m/z) 476 (MH⁺), RT=4.42, purity: 96%.

6n, 1-[2-(1, 3-Benzodioxolan-5-yloxy)phenyl]-4-[3-(5-fluoro-1H-indol-3-yl)propyl]piperazine: LC/MS (m/z) 474 (MH⁺), RT=4.25, purity: 99%.

6o, 1-[2-(1,3-Benzodioxolan-5-yloxy)phenyl]-4-[3-(5-iodo-1H-indol-3-yl)propyl]piperazine: LC/MS (m/z) 582 (MH³⁰ ), RT=4.58, purity: 85%.

6p, 1-(2-Phenoxyphenyl)-4-[3-(7-chloro-1H-indol-3-yl)propyl]piperazine: LC/MS (m/z) 430 (MH⁺), RT=4.38, purity: 87%.

6q, 1-(2-Phenoxyphenyl)-4-[3-(5, 7-difluoro-1H-indol-3-yl)propyl]piperazine: LC/MS (m/z) 448 (MH⁺), RT=4.44, purity: 84%.

6r, 1-[2-(2-Methoxyphenoxy)phenyl]-4-[3-(7-bromo-1H-indol-3-yl)propyl]piperazine: LC/MS (m/z) 520 (MH⁺), RT=4.50, purity: 77%.

6s, 1-(2-[3-(Dimethylamino)phenoxy]phenyl)-4-[3-(5-fluoro-1H-indol-3-yl)propyl]piperazine: LC/MS (m/z) 473 (MH⁺), RT=3.63, purity: 96%.

6t, 1-[2-(2-Methoxyphenoxy)phenyl]-4-[3-(5-iodo-1H-indol-3-yl)propyl]piperazine LC/MS (m/z) 568 (MH⁺), RT=4.63, purity: 82%.

6u, 1-[2-(1,3-Benzodioxolan-5-yloxy)phenyl]-4-[3-(5-chloro-1H-indol-3-yl)propyl]piperazine: LC/MS (m/z) 490 (MH⁺), RT=4.45, purity: 90%.

6v, 1-[2-(2,6-Dimethoxyphenoxy)phenyl]-4-[3-(5-chloro-1H-indol-3-yl)propyl]piperazine: LC/MS (m/z) 506 (MH⁺), RT=4.46, purity: 83%.

6w, 1-[2-(1,3-Benzodioxolan-5-yloxy)phenyl]-4-[3-(1H-pyrrolo[3,2-h]-quinolin-3-yl)propyl]piperazine: LC/MS (m/z) 507 (MH⁺), RT=3.30, purity: 97%.

6x, 1-[2-(2-Methoxyphenoxy)phenyl] -4-[3-(5, 7-difluoro-1H-indol-3-yl)propyl]piperazine: LC/MS (m/z) 478 (MH⁺), RT=4.36, purity: 75%.

⁶y, 1-(2-Phenoxyphenyl)-4-[3-(5-iodo-1H-indol-3-yl)propyl]piperazine: LC/MS (m/z) 5.38 (MH⁺), RT=4.69, purity: 92%.

⁶z, 1-[2-(2-Methoxyphenoxy)phenyl]-4-[3-(1H-pyrrolo[3,2-h]-quinolin-3-yl)propyl]piperazine: LC/MS (m/z) 493.2 (MH⁺), RT=3.29, purity: 96%.

6aa, 1-[2-(3-Methoxyphenoxy)phenyl]-4-[3-(1H-pyrrolo[3,2-h]-quinolin-3-yl)propyl]piperazine LC/MS (m/z) 493 (MH⁺), RT=3.38, purity: 96%.

6ab, 1-[2-(1,4-Benzodioxan-5-yloxy)phenyl]-4-[3-(5-methyl-1H-indol-3-yl)propyl]piperazine: LC/MS (m/z) 484 (MH⁺), RT=4.35, purity: 84%.

6ac, 1-[2-(2,6-Dimethoxyphenoxy)phenyl]-4-[3-(5-methyl-1H-indol-3-yl)propyl]piperazine: LC/MS (m/z) 486 (MH⁺), RT=4.38, purity: 80%.

6ad, 1-[2-(3-Methoxyphenoxy)phenyl]-4-[3-(1H-indol-3-yl)propyl]piperazine: LC/MS (m/z) 442 (MH⁺), RT=4.25, purity: 85%.

6ae, 1-[2-(1,4-Benzodioxan-5-yloxy)phenyl]-4-[3-(1H-indol-3-yl)propyl]piperazine: LC/MS (m/z) 471 (MH⁺), RT=4.13, purity: 83%.

6af; 1-[2-(1,3-Benzodioxolan-5-yloxy)phenyl]-4-[3-(5-hromo-1H-indol-3-yl)propyl]piperazine: LC/MS (m/z) 536 (MH⁺), RT=4.49, purity: 88%.

6ag, 1-{2-[3-(Morpholin-4-yl)phenoxy]phenyl}-4-[3-(5-fluoro-1H-indol-3-yl)propyl]piperazine: LC/MS (m/z) 515 (MH⁺), RT=4.17, purity: 94%.

6ah, 1-[2-(3-Methoxyphenoxy)phenyl]4-[3-(5-chloro-1H-indol-3-yl)propyl]piperazine: LC/MS (m/z) 476 (MH⁺), RT=4.53, purity: 92%.

6ai, 1-[2-(3-Ethoxyphenoxy)phenyl]-4-[3-(5-methyl-1H-indol-3-yl)propyl]piperazine. LC/MS (m/z) 470 (MH⁺), RT=4.68, purity: 85%.

6aj, 1-[2-(2,6-Dimethoxyphenoxy)phenyl]-4-[3-(5-iodo-1H-indol-3-yl)propyl]piperazine: LC/MS (m/z) 598 (MH⁺), RT=4.61, purity: 70%.

6ak, 1-{2-[3-(Diethylamino)phenoxy]phenyl}-4-[3-(5-fluoro-1H-indol-3-yl)propyl]piperazine: LC/MS (m/z) 501 (MH⁺), RT=3.18, purity: 87%.

6al, 1-[2-(2,6-Dimethoxyphenoxy)phenyl]-4-[3-(5-fluoro-1H-indol-3-yl)propyl]piperazine: LC/MS (m/z) 490 (MH⁺), RT=4.26, purity: 88%.

6am, 1-{2-[3-(Morpholin-4-yl)phenoxy]phenyl}-4-[3-(5-bromo-1H-indol-3-yl)propyl]piperazine: LC/MS (m/z) 475 (MH⁺), RT=4.42, purity: 78%.

6an, 1-{2-[3-(Morpholin-4-yl)phenoxy]phenyl}-4-[3-(5-chloro-1H-indol-3-yl)propyl]piperazine: LC/MS (m/z) 531 (MH⁺), RT=4.34, purity: 81 %.

6ao, 1-{2-[3-(Morpholin-4-yl)phenoxy]phenyl}-4-[3-(5-iodo-1H-indol-3-yl)propyl]piperazine: LC/MS (m/z) 623 (MH⁺), RT=4.56, purity: 71%.

6aq, 1-[2-(3-Methoxyphenoxy)phenyl]-4-[3-(7fluoro-1H-indol-3-yl)propyl]piperazine: LC/MS (m/z) 460 (MH⁺), RT=4.38, purity: 70%.

6ar, 1-(2-Phenoxyphenyl)-4-[3-(5,7-dimethyl-1H-indol-3-yl)propyl]piperazine: LC/MS (m/z) 440 (MH⁺), RT=4.64, purity: 78%.

6as, 1-[2-(1, 3-Benzodioxolan-5-yloxy)phenyl]-4-[3-(7-bromo-1H-indol-3-yl)propyl]piperazine: LC/MS (m/z) 534 (MH⁺), RT=4.46, purity: 75%.

6at, 1-[2-(3,4,5-Trimethoxyphenoxy)phenyl]-4-[3-(5-bromo-1H-indol-3-yl)propyl]piperazine: LC/MS (m/z) 580 (MH⁺), RT=4.34, purity: 81%.

6as, 1-[2-Methyl-3-(3,4,5-trimethoxyphenoxy)phenyl]-4-[3-(5fluoro-1H-indol-3-yl)propyl]piperazine: LC/MS (m/z) 534 (MH⁺), RT=4.34, purity: 84%.

6au, 1-{3-[3-(Diethylamino)phenoxy]-2-methylphenyl}-4-[3-(5-chloro-1H-indol-3-yl)propyl]piperazine: LC/MS (m/z) 531 (MH⁺), RT=3.62, purity: 80%.

6av, 1-{3-[3-(Diethylamino)phenoxy]-2-methylphenyl}-4-[3-(5,7-difluoro-1H-indol-3-yl)propyl]piperazine: LC/MS (m/z) 533 (MH⁺), RT=3.56, purity: 71%.

6ax, 1-{2-Methyl-3-(3,4,5-trimethoxyphenoxy)phenyl}-4-[3-(5-chloro-1H-indol-3-yl)propyl]piperazine: LC/MS (m/z) 550 (MH⁺), RT=4.51, purity: 77%.

6ay, 1-{3-[3-(Diethylamino)phenoxy]-2-methylphenyl}-4-[3-(1H-indol-3-yl)propyl]piperazine: LC/MS (m/z) 497 (MH⁺), RT=3.28, purity: 74%.

6az, 1-[3-(2, 6-Dimethylmorpholin-4-yl)-2-methylphenyl]-4-[3-(5-fluoro-1H-indol-3-yl)propyl]-1,4-diazepan: LC/MS (m/z) 479 (MH⁺), RT=4.29, purity: 91%.

6ba, 1-{3-[3-(Dimethylamino)phenoxy]-2-methylphenyl}-4-[3-(5-fluoro-1H-indol-3-yl)propyl]piperazine: LC/MS (m/z) 487 (MH⁺), RT=3.71, purity: 83%.

6bb, 1-[3-(1,3-Benzodioxolan-5-yloxy)-2-methylphenyl]-4-[3-(1H-indol-3-yl)propyl]piperazine: LC/MS (m/z) 470 (MH⁺), RT=4.40, purity: 77%.

6bc, 1-[3-(2, 6-Dimethylmorpholin-4-yl)-2-methylphenyl]-4-[3-(5-fluoro-1H-indol-3-yl)propyl]piperazine: LC/MS (m/z) 465 (MH⁺), RT=4.14, purity: 81%.

6bd, 1-{3-[3-(Diethylamino)phenoxy]-2-methylphenyl}-4-[4-(5-fluoro-1H-indol-3-yl)butyl]piperazine: LC/MS (m/z) 5295 (MH⁺), RT=3.50, purity: 70%.

6be, 1-[3-(Morpholin-4-yl)-2-metlylphenyl]-4-[3-(5-chloro-1H-indol-3-yl)propyl]piperazine: LC/MS (m/z) 453 (MH⁺), RT=3.97, purity: 84%.,

6bf 1-{3-[3-(Dimethylamino)phenoxy]-2-methylphenyl}-4-[3-(5-chloro-1H-indol-3-yl)propyl]piperazine: LC/MS (m/z) 503 (MH⁺), RT=3.96, purity: 87%.

6bg, (S)-1-[3-(2-Hydroxymethylpyrrolidin-1-yl)-2-methylphenyl]-4-[3-(1H-indol-3-yl)propyl]piperazine: LC/MS (m/z) 433 (MH⁺), RT=2.33, purity: 85%.

6bh, (S)-1-[3-(2-Hydroxymethylpyrrolidin-1-yl)-2-methylphenyl]-4-[3-(5-fluoro-1H-indol-3-yl)propyl]piperazine: LC/MS (m/z) 451.3 (MH⁺), RT=2.50, purity: 81%.

6bi, 1-[3-(1,3-Benzodioxolan-5-yloxy)-2-methylphenyl]-4-[3-(5-fluoro-1H-indol-3-yl)propyl]piperazine: LC/MS (m/z) 488 (MH⁺), RT=4.48, purity: 98%.

6bj, 1-{3-[3-(Dimethylamino)phenoxy]-2-methylphenyl}-4-[4-(5,7-difluoro-1H-indol-3-yl)butyl]piperazine: LC/MS (m/z) 519 (MH⁺), RT=4.09, purity: 70%.

6bk, (S)-1-[3-(2-Hydroxymethylpyrrolidin-1-yl)-2-methylphenyl]-4-[3-(5,7-difluoro-1H-indol-3-yl)propyl]piperazine: LC/MS (m/z) 469 (MH⁺), RT=2.67, purity: 75%.

6bl, 1-[3-(1, 3-Benzodioxolan-5-yloxy)-2-methylphenyl]-4-[3-(5,7-difluoro-1H-indol-3-yl)propyl]piperazine: LC/MS (m/z) 506 (MH⁺), RT=4.60, purity: 70%.

6bm, 1-[3-(2,6-Dimethylmorpholin-4-yl)-2-methylphenyl]-4-[3-(1H-indol-3-yl)propyl]-1,4-diazepane: LC/MS (m/z) 461 (MH⁺), RT=4.20, purity: 83%.

6bn, 1-[3-(2,6-Dimethylmorpholin-4-yl)-2-methylphenyl]-4-[3-(5,7-difluoro-1H-indol-3-yl)propyl]piperazine: LC/MS (m/z) 483 (MH⁺), RT=4.29, purity: 75%.

6bo, 1-{(3-[3-(Diethylamino)phenoxy]-2-methylphenyl}-4-[3-(5,7-difluoro-1H-indol-3-yl)propyl]-1,4-diazepane: LC/MS (m/z) 547 (MH⁺), RT=3.61, purity: 76%.

6bp, 1-{3-[3-(Dimethylamino)phenoxy]-2-methylphenyl}-4-[3-(1H-indol-3-yl)propyl]-1,4-diazepane: LC/MS (m/z) 483 (MH⁺), RT=3.78, purity: 72%.

6bq, 1-(3-[3-(Dimethylamino)phenoxy]-2-methylphenyl)-4-[3-(5,7-difluoro-1H-indol-3-yl)propyl]piperazine: LC/MS (m/z) 505 (MH⁺), RT=3.94, purity: 85%.

6br, 1-[3-(Morpholin-4-yl)-2-methylphenyl]-4-[3-(5-fluoro-1H-indol-3-yl)propyl]-1,4-diazepane: LC/MS (m/z) 451 (MH⁺), RT=3.82, purity: 88%.

6bs, 1-{3-[3-(Diethylamino)phenoxy]-2-methylphenyl}-4-[4-(5-chloro-1H-indol-3-yl)butyl]piperazine: LC/MS (m/z) 545 (MH⁺), RT=3.77, purity: 82%.

6bt, 1-[3-(1,3-Benzodioxolan-5-yloxy)-2-methylphenyl]-4-[3-(5-fluoro-1H-indol-3-yl)propyl]-1,4-diazepane: LC/MS (m/z) 502 (MH⁺), RT=4.56, purity: 75%.

6bu, 1-{3-[3-(Diethylamino)phenoxy]-2-methylphenyl}-4-[4-(5,7-difluoro-1H-indol-3-yl)butyl]piperazine: LC/MS (m/z) 547 (MH⁺), RT=3.69, purity: 87%.

6bv, 1-{3-[3-(Morpholin-4-yl)phenoxy]-2-methylphenyl}-4-[3-(5-fluoro-1H-indol-3-yl)propyl]-1,4-diazepane: LC/MS (m/z) 543 (MH⁺), RT=4.45, purity: 75%.

6bw, (S)-1-[3-(2-Hydroxymethylpyrrolidin-1-yl)-2-methylphenyl]-4-[3-(5-chloro-1H-indol-3-yl)propyl]piperazine: LC/MS (m/z) 467 (MH⁺), RT=2.75, purity: 70%.

6bx, 1-[3-(1,3-Benzodioxolan-5-yloxy)-2-methylphenyl]-4-[3-(5-chloro-1H-indol-3-yl)propyl]-1,4-diazepane: LC/MS (m/z) 504 (MH⁺), RT=4.66, purity: 74%.

6by, 1-[3-(2,6-Dimethylmorpholin-4-yl)-2-methylphenyl]-4-[3-(5,7-difluoro-1H-indol-3-yl)propyl]-1,4-diazepane: LC/MS (m/z) 497 (MH⁺), RT4.42, purity: 76%.

What is claimed is:

1. A method for preparation of substituted benzene derivatives by solid phase synthesis by subjecting the polymer bound intermediate of formula IV, to a complex of formula V resulting in the complex of formula VII, which is then subjected to the nucleophile R³′H and is subsequently and optionally subjected to the nucleophile R⁴′H to obtain compounds of formula VIII: 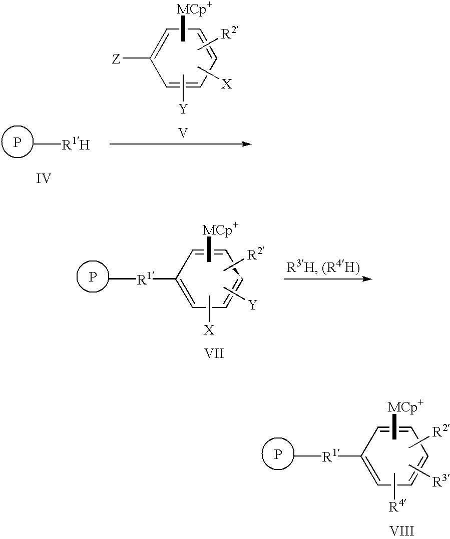
wherein R³′H and R⁴′H each have one reactive nucleophile centre under the reaction conditions applied or R³ H and R⁴′H are symmetrical; R² represents an optional substituent; X and Y represent hydrogen or halogen, with the proviso that they are not both hydrogen; Z is halogen;
\mathring{P} represents the solid support;
MCp⁺ represents 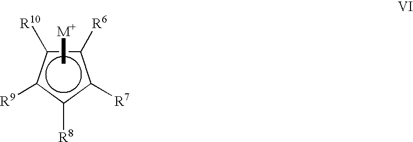
wherein R⁶-R¹⁰ represent hydrogen or C₁₋₆-alkyl; M is Fe or Ru; and the positively charged complexes of formula V, VII and VIII all contain a counterion;
after which the selectively substituted benzene derivative VIII is decomplexed, optionally derivatised, cleaved from the support, and optionally further derivatised.

2. The method according to claim 1 wherein the cleavage and derivatisation is performed simultaneously and involves the linking functional groups: 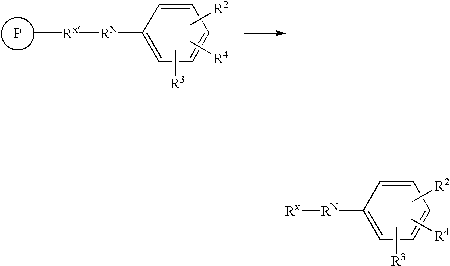
wherein HR^{N}H is a diamine such as a group of the formula:
HN(R^{e})—(CR^{a}R^{b})ₚ—L—(CR^{c}R^{d})_{q}—(R^{f})NH XI
wherein R^{e} and R^{c} independently represent hydrogen or alkyl or R^{e} and R^{c} together form a ring; R^{a}, R^{b}, R^{c} and R^{d} represent hydrogen or optional substituents and p is 0, 1 or 2 and q is 1 or 2; L represents a heteroatom such as O, S, Se, NH, NR^{L} wherein R^{L} represents an optional substituent which does not interfere with the applied reaction sequence, or L represents a bond; optionally one of R^{a} or R^{b} together with one of R^{c} or R^{d} form a ring structure, or R^{a} and R^{b} or R^{c} and R^{d} together form a ring and the rings can all then be further substituted;
and the 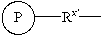
is represented by the formula XII 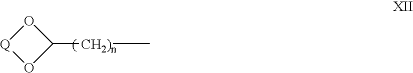
wherein n is 1-12 and Q(OH)₂ is a polymer bound diol;
and said cleavage and derivatisation is performed by reacting the decomplexed intermediate with an optionally substituted hydrazine of the formula 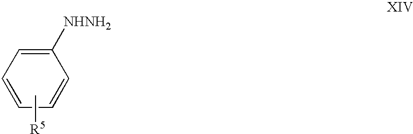
wherein R⁵ represents one or more optional substitutents with the proviso that one of the ortho-positions to the hydrazine substituent are unsubstituted; whereby an indole derivative of the formula: 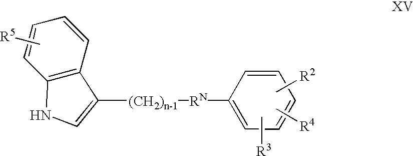
is formed simultaneously with cleavage from the solid support.

3. The method of claim 1 or 2 wherein HR^{N}H or HR¹H represents piperazine or homopiperazine.

4. The method of claim 2 wherein the simultaneous cleavage and derivatisation is performed as a one-pot procedure using a Lewis acid catalyst, or a protic acid, in a solvent, at an elevated temperature.

5. The method of claim 4 wherein the Lewis acid is zinc chloride or boron fluoride.

6. The method of claim 4 wherein the protic acid is selected from the group consisting of sulfonic acid and phosphoric acid.

7. The method of claim 6 wherein the solvent is acetic acid or ethanol.

8. The method of claim 1 wherein a simultaneous cleavage and derivatisation is performed where the linking functionality of the polymer support is a carbamate-derivative, and a nucleophile R¹¹OH, wherein R¹¹ is alkyl, which is optionally further substituted by further substituents, with the proviso that R¹¹ is not further unsymmetrically substituted with other nucleophiles capable of reacting at the reaction centre, is added.

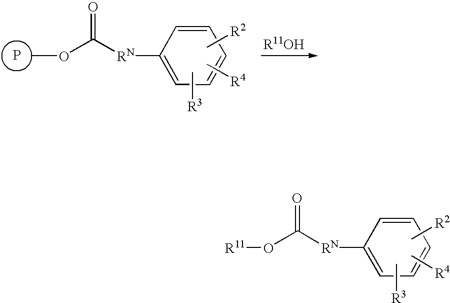

9. The method of claim 1 wherein M represents Fe.

10. The method of claim 1 wherein the groups R¹′, R³′ and R⁴′ independently represent RSe, RS, RO, or R′RN, or R″R′″CH, wherein R represents a suitable chosen chemical moiety with restrictions not to contain structural elements which can interfere with the reaction sequence applied, R′ is hydrogen, or alone or together with R form a suitable chosen chemical moiety with restrictions not to contain structural elements which can interfere with the reaction sequence applied; and R″ and R′″ represent groups which are suitable for stabilising the carbanion R″R′″CH⁻.

11. A method of claim 1 wherein R³′H represents aryl-OH, alkyl-OH, aryl-SH, alkyl-SH, cycloalkyl-OH, cycloalkyl-SH, alkyl-SeH, aryl-SeH, or R¹⁷R¹⁸NH wherein R¹⁷ and R¹⁸ independently represent alkyls or R¹⁷ and R¹⁸ together form a 4-8-membered ring which optionally contain further heteroatoms and which is optionally substituted one or more times, and which is optionally partially saturated and wherein the aryls and alkyls are optionally further substituted.

12. The method of claim 11 wherein R³′H represents aryl-OH, aryl-SH, aryl-SeH wherein the aryl is optionally substituted one or more times with substituents such as alkyl, aryl, alkoxy, alkylsulfanyl, dialkylamino wherein the dialkyls are optionally forming a 4-8-membered ring, which optionally contains further nitrogen, oxygen or sulphur atoms.

13. The method of claim 10 wherein R³′H represents phenol, 5-hydroxy-1,3-benzodioxolane, 5-hydroxy-1,4-benzodioxane, 2-methoxyphenol, 3-dimethylaminophenol, 4-methylphenol, 4-methylsulfanylphenol, 2-methylphenol, 4-methoxyphenol, 2,6-dimethoxyphenol, 3-(4-morpholinyl)phenol, 3,4,5-trimethoxyphenol, 3-diethylaminophenol, selenophenol or thiophenol.

14. The method of claim 9, wherein R¹⁷R¹⁸NH represent morpholine, piperazine, 2,6-dimethylmorpholine, 2-hydroxymethylpyrrolidine.

15. The method of claim 11, wherein R3′H represents alkyl-X^{N}H, alkoxyalkyl-X^{N}H or cycloalkyl-X^{N}H wherein X^{N} is O, S, Se, or NR′ wherein R′ is hydrogen or a substituent which does not interfere with the reaction sequence.

16. The method of claim 1 wherein R³′H and R⁴′H are identical.

17. The method of claim 1 wherein R³′H and R⁴′H together are forming a bi-functional nucleophile.

18. The method of claim 17 wherein HR³′-R⁴′H is a diamino-alkyl, dihydroxy-alkyl, disulfanyl-alkyl, di-seleno-alkyl, ortho-dihydroxy-aryl, ortho-disulfanyl-aryl, ortho-di-seleno-aryl.

19. The method of claim 18 wherein HR³′-R⁴′H is an ethylene-diamine or a 2,3-dihydroxy-naphtyl.

20. A library or a collection of a plurality of compounds prepared by the method of claim 1.

21. A library or a collection of compounds according to claim 20, wherein the compounds are attached to the solid support.
